(19) United States
(12) Patent Application Publication
(10) Pub. No.: US 2023/0226852 A1
(43) Pub. Date: Jul. 20, 2023

(54) RELEASABLE WHEEL MOUNT SYSTEM FOR A ROLLATOR

(71) Applicant: Topro Industri AS, Gjøvik (NO)

(72) Inventor: Cosmin CIOROIU, Gjøvik (NO)

(21) Appl. No.: 17/998,148

(22) PCT Filed: May 6, 2021
(86) PCT No.: PCT/NO2021/050116

§ 371 Date: Nov. 7, 2022

(30) Foreign Application Priority Data
May 8, 2020 (NO) 20200541

(51) Int. Cl. B60B 37/10; A61H 3/04; B60B 35/04

(52) U.S. Cl. CPC B60B 37/10; A61H 3/04; B60B 35/04; A61H 2201/0107

(57) ABSTRACT

The invention describes a releasable wheel mount system for a rollator comprising a wheel axel (1) fastened to a frame (2) comprising a groove (3) near an outer end of the wheel axel (1) and a circular sloped gliding surface (25) at the outer end. The system further comprises a release trigger (4) engaging the groove (4) by means a locking shape (5) locking the release trigger (4) and wheel axel (1) to each other, and releasing the release trigger (4) from the wheel axel (1) a releasing shape (6). The system further comprises a housing (7) with a central cylinder (8) with a cavity accommodating the wheel axel (1), an outer (9) and inner (10) rim stopper, and a trigger cavity (11) accommodating the release trigger, thus locking the release trigger (4) and housing (7) to each other and to the wheel axel.

### FIELD OF INVENTION

This invention relates to support materials for elderly or disabled persons, more specifically to a releasable wheel mount system for a rollator.

### BACKGROUND

The number and percentage of people using walking aids is increasing in most parts of the world, and the quality of life for these users depends on various support materials. Rollators are one of the most important ones and enable the users to remain independent and carry out everyday tasks like shopping and move around according to own free will.

As users become more numerous and the number of firms selling rollators increases issues like design and user friendliness become more important. Easy and cheap maintenance of the rollator is very important, and the wheels are one of the parts that needs maintenance and/or replacement from time to time.

Easy replacements of the wheels will enable many users to maintain their own rollator, which in turn gives the user a sense of control and self-esteem and at the same time saves considerable costs when the service people don't have to solve the problem themselves, but instead are able to, for instance, simply send a spare wheel in the post.

A known solution for a releasable wheel mount is disclosed in U.S. Pat. No. 5,800,023 A which discloses a releasable wheel mount system for a child stroller, a bassinet, a baby buggy or similar device comprising a wheel axel 18 comprising a groove 902, 904 near an outer end of the wheel axel 18 and a circular sloped gliding surface 25 at the outer end, and two moving members 202, 204. each comprising one shape. The downside of this solution is that the wheel is cumbersome to attach and release from the wheel mount and it requires a use two push two moving members in order for the wheel mount to release the axel. A further solution is disclosed in US 2005057086 A1 which discloses a releasable wheel mount system, wherein a wheel axel 30 comprising a groove 32 near an outer end of the wheel axel 30, an insert 10 for retaining the wheel, a rotatable plate 12 with a protrusion 19 and a clip 20 for engaging the groove 32 and protrusion 19 of the wheel axel 30 in a locked state.

### SUMMARY OF THE INVENTION

The invention describes a releasable wheel mount system for a rollator. The system comprises a wheel axel, a release trigger and a housing. The wheel axel is fastened to a frame of a rollator and comprises a groove near an outer end of the wheel axel and a circular sloped gliding surface at the outer end. The release trigger comprises a locking shape with a locking surface for engaging the groove of the wheel axel in a locked state, thus locking the release trigger and wheel axel to each other, and a releasing shape, wherein the releasing shape is a circular hole bigger than the axel, for releasing the release trigger from the wheel axel in a releasing so state. The locking shape is a semi-circular indent at the lower end of the releasing shape, wherein the indent has a radius bigger than the radius of a circular circumferential groove of the axel. The housing comprises a central cylinder with a cavity accommodating the wheel axel with a clearance, an outer rim stopper, an inner rim stopper, and a trigger cavity accommodating the release trigger, locking the is release trigger and housing to each other. The release trigger is biased towards the locked state by use of biasing means and is operable to be pushed or pulled into the releasing state by a user.

### BRIEF DESCRIPTION OF THE DRAWINGS

For better understanding of the invention, a set of drawings is provided. Like numerals on different drawings describe the same feature.

FIG. 1 shows the wheel axel.

FIG. 2a, 2b shows a front and side view of the release trigger.

FIGS. 3a and 3b shows a front and side view of the housing.

FIG. 4 shows an explode view of all the parts of the invention and bearings, a rim and a tire.

FIG. 5a, 5b shows a rear and perspective view of an axel mounted to the rear of a frame of a rollator.

### DETAILED DESCRIPTION

Below is a description of a releasable wheel mount system for a rollator. Up and down, back and front, left and right are as seen by a user under normal use of the rollator.

The system comprises three main separate parts: A wheel axel 1, a release trigger 4 and a housing 7. Preferably, there is also at least one bearing between the rim 13 to be mounted and the housing 7. However, the bearings could also be integral to the rim and is not regarded as part of the invention.

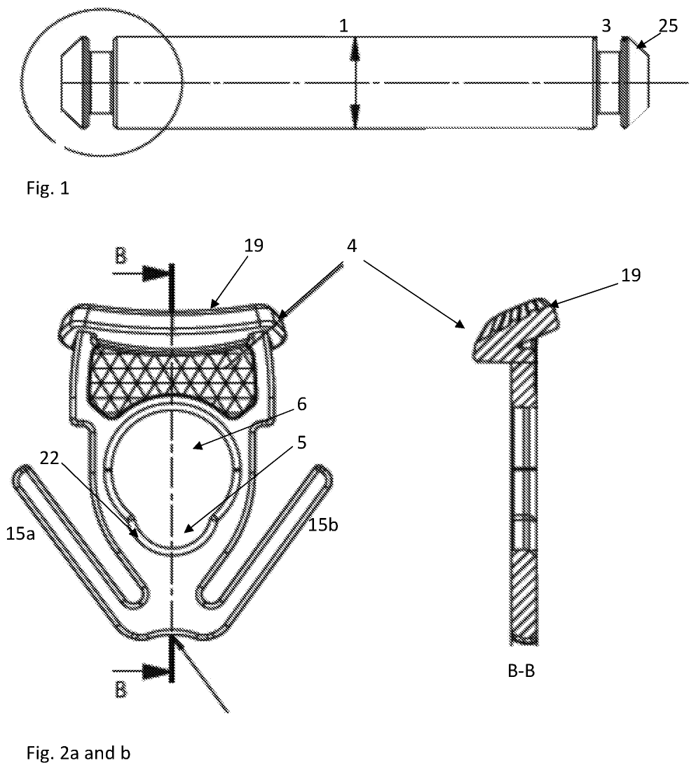

The wheel axel 1 of the system is shown in FIG. 1 and is fastened to the frame 2 of the rollator and comprises a circumferential groove 3 near the outer end of the wheel axel 1. Preferably the groove has a rectangular cross-section.

An embodiment of the release trigger 4 of the system is shown in FIG. 2 and comprises a locking shape 5 with a locking surface 22 for engaging the circumferential groove 3 of the wheel axel 1 in a locked state, thus locking the release trigger 4 and wheel axel 1 to each other. The release trigger further comprises a releasing shape 6 for releasing the wheel from the wheel axel 1 in a releasing state.

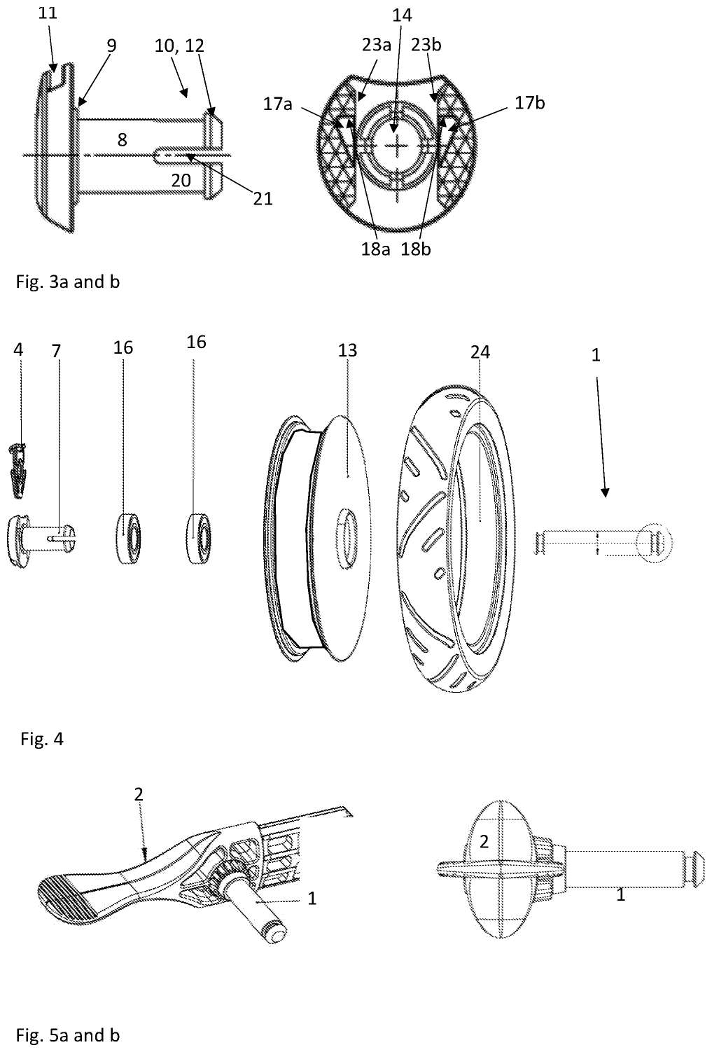

An embodiment of the housing 7 of the system is shown in FIG. 3 and comprises a central cylinder 8 with an axel cavity 14 accommodating the wheel axel 1 with a clearance. The housing further comprises an outer and inner rim stopper 9, 10 to prevent the rim from moving sideways on the axel. Furthermore, the housing comprises a trigger cavity 11 accommodating the release trigger, which locks the release trigger 4 and housing 7 to each other.

The release trigger 4 is biased towards the locked state by use of biasing means 15 and is operable to be pushed or pulled into the releasing state by a user acting against the bias.

In a preferred embodiment the housing and release trigger is casted in a resilient plastic material. This will provide a cost effective and durable quick release system for mounting a wheel on a rollator.

In one embodiment, shown in FIG. 3, the inner rim stopper 10 of the housing 7 comprises at least two separate resilient snap arms 20 each with at least one snap protrusion 12 at their outer ends extending radially more than the clearance between the wheel axle 1 and the central cylinder 8. Preferably the resilient snap arms 20 are made when casting the housing 7. The slots 21 give the resilient snap arms freedom to move inwards. This snap on system is well known in the art. The idea is that the stopper arms shall function as the well-known snap on system when the axel is not present and that the axel, when present, will stop the snap on function from disengaging because the axel prevents radial inward movement of the resilient snap arms 20.

Preferably the locking shape 5 of the release trigger 4 has the same shape as the groove and fits into the groove with locking surfaces 22 at a mainly perpendicular angel to the central axis of the wheel axel 1. In one embodiment the locking shape 5 is a semi-circular shape with radius slightly bigger than a radius of a circular embodiment of the circumferential groove 3 as seen in FIGS. 1 and 2. In one embodiment the releasing shape 6 is a circular hole bigger than the wheel axel. The is release shape and the locking shape 5 respectively correspond to a releasing position and a locking position of the release trigger 4 inside the trigger cavity 11.

In one advantageous embodiment the biasing means 15 is a resilient arm 15a, b on each side of the release trigger 4 at an angle to the centerline and fitting into indents 17a, b in the trigger cavity 11 preventing retraction of the release trigger 4 from the trigger cavity. The resilient trigger arms 15a, b and the indents 17a, b should function such that the release trigger 4 is biased towards the locking position and does not fall out of the trigger cavity 11. In one embodiment this is achieved by the trigger cavity having constriction sides 23a, b with triangular indents 17a, b, each with a mainly horizontal stopping surfaces 18a and 18b at the top as seen in FIG. 3. The resilient trigger arms 15a, b will slide over the mainly parallel constriction sides 23a, b located at opposite sides of the trigger cavity 11 when the release trigger is inserted in the trigger cavity 11 and the trigger arms 15a, b will then click into the triangular indents. The resilient arms will stop against the horizontal surface if retraction of the release trigger is attempted. This position is the locking position and the resilient arms are not exerting any forces on the release trigger that would cause it to move in the vertical direction. Below the indents 17a, b a continuation of the constriction sides 23a, b causes the resilient trigger arms 15 to exert an upward force on the releasing trigger if it is pushed further down, thus biasing the releasing trigger towards the locked state. This is because there is a distance dc between the constriction sides 23a, b which is considerably shorter than the distance da between the top of the unbiased resilient trigger arms.

A corresponding triangular indent (17a, b) on each constriction side (23a, b) with a mainly horizontal top surface (18a, b) into which the resilient trigger arms will fit when the release trigger is inserted. The releasing trigger has a push plate 19 at the top, which stops further downward movement of the release trigger when the push plate hits the housing. This must happen before the top of the resilient arms 15 have moved below the indents 17. At this lower position the release trigger 4 is in a releasing position and the housing can be retracted form the axel.

In a preferred embodiment the axel 3 is provided with a circular sloped gliding surface 25 which enables the locking shape to glide over the gliding surface and into the groove 3 when the housing and release trigger is pushed onto the wheel axel 1.

FIG. 4 shows all the parts of the system and a rim in an exploded view. Two bearings 16 are also present in the figure, obviously the bearings could be integrated in the rim, hence, fitting the bearings is not part of the inventive method. In this embodiment the method for mounting and demounting a wheel using a releasable wheel mount system for a rollator according to the invention comprises the following steps:
a) Inserting the release trigger 4 into the trigger cavity 11 of the housing,
b) Fitting the housing 7 into the center of the rim. This is possible because there is no axel present inside the resilient snap arms 20.
c) Pushing the rim and housing onto the wheel axel 1 until the locking shape 5 of the release trigger clicks into the groove 3, thus having mounted the wheel,
d) Pushing the push plate 19 of the release trigger 4. This will cause the locking shape 5 to exit the groove 3.
e) Pulling the rim and housing off the wheel axel 1, thus having demounted the wheel.

FIGS. 5a and 5b shows different perspectives of the axel for a rear wheel mounted on the frame of the rollator.

### Inventory

1 Wheel axel
2 Frame
3 Groove
4 Release trigger
5 Locking shape
6 Releasing shape
7 Housing
8 Central cylinder
9 Outer rim stopper
10 Inner rim stopper
11 Trigger cavity
12 Stopper protrusion
13 Rim
14 Axel cavity
15/15a, b Biasing means/resilient trigger arms
16 Bearing
17a, b Indent
18a, b Stopping surface
19 Push plate
20 Snap latches
21 Slots
22 Locking surface
23a, b Constriction sides
24 Tire
25 Circular sloped gliding surface

1. Releasable wheel mount system for a rollator comprising:
a wheel axel fastened to a frame of a rollator comprising a groove near an outer end of the wheel axel and a circular sloped gliding surface at the outer end,
characterized by a release trigger comprising:
a locking shape with a locking surface for engaging the groove of the wheel axel in a locked state, thus locking the release trigger and wheel axel to each other, and
a releasing shape that is a circular hole bigger than the axel for releasing the release trigger from the wheel axel in a releasing state, and
wherein the locking shape is a semi-circular indent at the lower end of the releasing shape, wherein the semi-circular indent has a radius bigger than the radius of a circular circumferential groove of the axel,
wherein the wheel mount system further comprises a housing comprising:
a central cylinder with a cavity accommodating the wheel axel with a clearance,
an outer rim stopper,
an inner rim stopper, and
a trigger cavity accommodating the release trigger, locking the release trigger and housing to each other, and
wherein the release trigger is biased towards the locked state by use of biasing means and is operable to be pushed or pulled into the releasing state by a user.

2. System according to claim 1 wherein the inner rim stopper comprises at least two separate resilient stopper arms each with at least one stopper protrusion at their outer ends extending radially more than the clearance between the wheel axle and the central cylinder.

3.-4. (canceled)

5. System according to claim 1 wherein the biasing means comprises:
a resilient trigger arm on each side of the release trigger at an angle to its central line and pointing upwards,
a constriction side on opposite sides of the trigger cavity working together with the resilient trigger arms and having a distance dc between them considerably shorter than the distance da between the top of the unbiased resilient trigger arms,
a corresponding triangular indent on each constriction side with a mainly horizontal top surface into which the resilient trigger arms will fit when the release trigger is inserted, and
wherein the constriction sides continues below the indents.

6. System according to claim 1 wherein the housing and release trigger is casted in a resilient plastic material.

7. Method for mounting and demounting a wheel using a releasable wheel mount system for a rollator according to claim 1 characterized by comprising the following steps:
inserting the release trigger into the trigger cavity of the housing,
fitting the housing into the center of the rim,
pushing the rim and housing onto the wheel axel until the locking shape of the release trigger clicks into the groove, thus having mounted the wheel,
pushing the push plate of the release trigger
pulling the rim and housing off the wheel axel, thus having demounted the wheel.
